(19) United States
(12) Patent Application Publication
(10) Pub. No.: US 2022/0274069 A1
(43) Pub. Date: Sep. 1, 2022

(54) CONDUCTIVE MEMBRANE AND PREPARATION METHOD THEREOF

(71) Applicant: HARBIN INSTITUTE OF TECHNOLOGY, SHENZHEN, Shenzhen (CN)

(72) Inventors: FEIYUN SUN, Shenzhen (CN); Jingyi Yang, Shenzhen (CN); Wenyi Dong, Shenzhen (CN); Lingyan Zhao, Shenzhen (CN); Dingyu Xing, Shenzhen (CN); Songwen Yang, Shenzhen (CN); Zi Song, Shenzhen (CN); Ji Li, Shenzhen (CN)

(21) Appl. No.: 17/743,418

(22) Filed: May 12, 2022

Related U.S. Application Data
(63) Continuation of application No. PCT/CN2019/121775, filed on Nov. 28, 2019.

(51) Int. Cl. B01D 69/14; B01D 69/02; B01D 69/12; B01D 71/02; B01D 67/00; B01D 71/68; B01D 61/42; C08J 5/18; C08K 3/04; C08K 9/04

(52) U.S. Cl. CPC B01D 69/148; B01D 69/02; B01D 69/12; B01D 71/021; B01D 67/0079; B01D 67/0013; B01D 67/0011; B01D 71/68; B01D 61/42; C08J 5/18; C08K 3/042; C08K 9/04; B01D 2325/025; B01D 2325/026; B01D 2325/022; B01D 2325/04; B01D 2323/18; B01D 2323/06; B01D 2323/08; B01D 2325/26; C08K 2201/001; C08K 2201/011; C08J 2381/06; C08J 2333/20; C08J 2327/16; C08J 2301/12

(57) ABSTRACT

The present application discloses a conductive membrane and a preparation method thereof, which belong to the field of membrane separation technology. The conductive membrane provided by the present application includes a porous base layer film, a porous intermediate layer film, and a porous conductive layer film which are disposed layer by layer in sequence; wherein at least some holes of the base layer film are communicated with holes of the conductive layer film through holes of the intermediate layer film, and material of the intermediate layer film is the same as material of the base layer film and of the conductive layer film. Regarding the conductive membrane provided by the present application, it can be coupled with electrochemical technology, so that the membrane exhibits new excellent properties at the same time of playing separating characteristic.

### CROSS-REFERENCE TO RELATED APPLICATIONS

The present application is a continuation-application of International (PCT) Patent Application No. PCT/CN2019/121775 filed on Nov. 28, 2019, with a title of “CONDUCTIVE MEMBRANE AND PREPARATION METHOD THEREOF”; the entire content thereof is incorporated herein by reference.

### TECHNICAL FIELD

The present application relates to the field of membrane separation technology, and in particular, to a conductive membrane and a preparation method thereof.

### BACKGROUND

Nanofiltration separation membrane has become a membrane treatment technology with promising application scene in advanced treatment of domestic sewage and industrial wastewater compliance and reuse treatment, because its interception efficiency is much higher than that of microfiltration and ultrafiltration membranes, and its operation pressure is significantly lower than that of reverse osmosis membranes. However, there are two main problems in the application of nanofiltration membrane separation technology. One is that a high operating pressure in an external pressure driving mode leads to high energy consumption (a driving pressure of a nanofiltration membrane ranges from 0.5 MPa to 2 MPa), and the other is that rapid decline in membrane flux caused by membrane fouling, frequent cleaning for membrane fouling, and increased operating costs of membrane processes lead to high material consumption.

### SUMMARY OF THE DISCLOSURE

The present application mainly solves a technical problem of providing a conductive membrane and a preparation method thereof, which can reduce energy consumption and material consumption in application processes of nanofiltration membranes.

In order to solve the above technical problem, one technical solution adopted by the present application is to provide a conductive membrane comprising a porous base layer film, a porous intermediate layer film, and a porous conductive layer film which are disposed layer by layer in sequence; wherein at least some holes of the base layer film are communicated with holes of the conductive layer film through holes of the intermediate layer film, and material of the intermediate layer film comprises material of the base layer film and of the conductive layer film.

In order to solve the above technical problem, another technical solution adopted by the present application is to provide a method for preparing a conductive membrane comprising: coating first film casting liquid on a base board; coating second film casting liquid on the first film casting liquid; and placing the base board coated with the first film casting liquid and the second film casting liquid in water bath to obtain the conductive membrane; wherein a part of the first film casting liquid abutting the base board generates phase transformation and solidifies to be a base layer film of the conductive membrane, a part of the second film casting liquid distancing from the base board generates phase transformation and solidifies to be a conductive layer film of the conductive membrane, and other second film casting liquid and other first film casting liquid merge with each other, generate phase transformation, and solidify into an intermediate layer film of the conductive membrane.

Advantageous effect of the present application is that: differing from the situation of the prior art, the conductive membrane provided by the present application, on the basis of a traditional separation membrane, can couple it with electrochemical technology, so that the membrane, at the same time of playing separating characteristic, exhibits new excellent properties such as anti-fouling, enhancing membrane flux, degrading pollutants, regulating selective permeability of membranes, and so on. The configuration of the three-layer porous membrane structure enables the conductive membrane provided by the present application to reduce the resistance of the membrane body, obtain high retention efficiency and high solution permeation under low pressure driving, so that operating energy consumption can be reduced; the existence of the conductive film layer enables the conductive membrane provided by the present application to be coupled with electrochemical technology, and use the principles of electrostatic repulsion, electro-bubble, electrochemical redox, electro-structural change, electro-wetting, and so on to improve separation characteristics of the membrane and reduce pollution of the membrane, so that material consumption can be reduced.

### BRIEF DESCRIPTION OF THE DRAWINGS

In order to describe technical solutions in embodiments of the present application more clearly, drawings required being used in description of the embodiments will be simply introduced below. Obviously, the drawings in the following description are merely some embodiments of the present application. For one of ordinary skill in the art, it is also possible to obtain other drawings according to these drawings without paying any creative work.

FIG. 1 is a structural schematic view of an embodiment of a conductive membrane of the present application.

FIG. 2 is a schematic view of an embodiment of a conductive membrane of the present application in a scanning electron microscope.

FIG. 3 is another schematic view of an embodiment of a conductive membrane of the present application in a scanning electron microscope.

FIG. 4 is a schematic flow chart of an embodiment of a method for preparing a conductive membrane of the present application.

FIG. 5 is a schematic flow chart of a specific implementation example of a method for preparing a conductive membrane of the present application.

### DETAILED DESCRIPTION

The technical solutions in the embodiments of the present application will be clearly and completely described below in combination with the accompanying drawings in the embodiments of the present application. Obviously, the described embodiments are only some of embodiments of the present application, rather than all embodiments. Based on the embodiments of the present application, all other embodiments obtained by those ordinarily skilled in the art without any creative work shall fall within the protection scope of the present application.

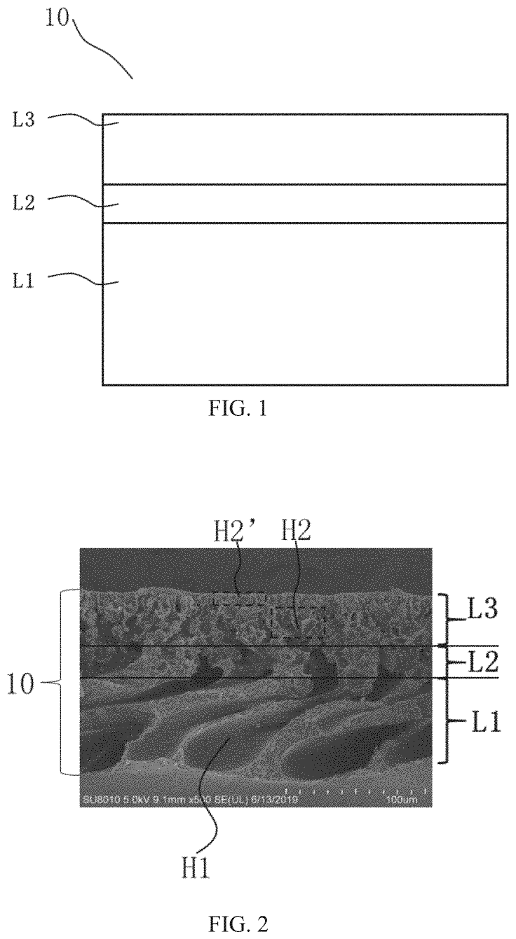

Referring to FIG. 1, FIG. 1 is a structural schematic view of an embodiment of a conductive membrane of the present application. The conductive membrane 10 includes a porous base layer film L1, a porous intermediate layer film L2, and a porous conductive layer film L3, which are disposed layer by layer in sequence; among them, at least some holes of the base layer film L1 are communicated with holes of the conductive layer film L3 through holes of the intermediate layer film L2, and material of the intermediate layer film L2 includes material of both the base layer film L1 and of the conductive layer film L3.

Differing from the prior art, the conductive membrane 10 provided by this embodiment is provided on a surface thereof with the conductive layer film L3, which contains a conductive support network, which can promote migration of electrons on a film surface, thereby changing charge density on the film surface. In a condition of external electric field, electrostatic repulsion, electrophoresis, electro-bubble and other effects are generated between the film surface and charged pollutants in water, thereby effectively inhibiting film pollution. The intermediate layer film L2 and a base layer film L1 are arranged under the conductive layer film L3, in a sewage treatment process, since the intermediate layer film L2 provides more channels communicating with the base layer film L1, the sewage can flow evenly into the base layer film L1 after passing through the conductive layer film L3, thereby generating a uniform water pressure and improving a membrane flux. Moreover, existence of the conductive layer film L3 enables the conductive membrane to be coupled with electrochemical technology, uses principles such as electrochemical redox to decompose charged pollutants, and further improves interception efficiency.

The base layer film L1 of this embodiment includes first polymer film material, optionally, the first polymer film material may include at least one of polyethersulfone (PES), polyacrylonitrile (PAN), polyvinylidene fluoride (PVDF), polysulfone (PSF), and cellulose acetate (CA); the conductive layer film L3 includes second polymer film material and conductive modified material, optionally, the second polymer film material may include at least one of polyethersulfone (PES), polyacrylonitrile (PAN), polyvinylidene fluoride (PVDF), polysulfone (PSF), and cellulose acetate (CA); the conductive modified material includes graphene and carboxylated multi-wall carbon nanotubes; the intermediate layer film L2 includes the first polymer film material, the conductive modified material, and the second polymer film material. Preferably, the first polymer film material is the same as the second polymer film material.

Differing from the prior art, the conductive layer film L3 of the conductive membrane 10 provided by this embodiment of the present application includes graphene and carboxylated multi-walled carbon nanotubes as conductive modified material, and the second polymer film material; wherein the second polymer film material and uniformly dispersed carboxylated multi-walled carbon nanotubes form a conductive support network in the conductive layer film L3, the addition of graphene plays a role in reducing holes and bridging connections, thereby making distribution of holes be more fine and uniform, and further connecting the conductive support network to improve conductivity of the conductive membrane. At the same time, in a nanoscale spatial scale, charge bias of hydrogen bonds of large water molecular clusters is eliminated by almost superconducting nanographene due to the cohesion force of the charge bias, an equipotential difference is formed, and the large water molecular clusters are decomposed into small water molecular clusters. The small water molecular clusters are easier to pass through the pore structures of each layer of film of the conductive membrane 10 in this embodiment; in addition, graphene is not hydrophilic, water molecules entering the film body slide without resistance in the holes, which reduces resistance of the film body, thereby reducing external pressure loss and lowering energy consumption.

Referring to FIG. 2, FIG. 2 is a schematic view of an embodiment of a conductive membrane of the present application in a scanning electron microscope. The holes of the base layer film L1 include finger-shaped holes H1, the holes of the conductive layer film L3 include spongy holes H2 and columnar holes H2′, and the holes of the intermediate layer film L2 include the spongy holes H2 and the finger-shaped holes H1; among them, the columnar holes H2′ are distributed on a surface of the conductive layer film L3 distancing from the base layer film L1, and the spongy holes H2 are distributed on an interface of the conductive layer film L3 closed to the intermediate layer film L2. In this embodiment, sizes of the holes of the base layer film L1, the intermediate layer film L2, and the conductive layer film L3 reduce in sequence. Among them, in a direction from the base layer film L1 to the conductive layer file L3, the finger-shaped holes H1 of the base layer film L1 have diameters of 15-50 micrometers and lengths of 30-200 micrometers; and/or in the direction from the base layer film L1 to the conductive layer file L3, diameters of the spongy holes H2 of the conductive layer film L3 are less than or equal to 10 micrometers, and the columnar holes H2′ have diameters of 100 nanometers to 1 micrometer and lengths being less than or equal to 10 micrometers. The conductive membrane 10 of this embodiment includes holes of different shapes and different sizes; in the absence of an external electric field, the intricate distribution of holes can increase amount of water infiltration and improve contact probability with pollutants; moreover, the carboxylated multi-walled carbon nanometer tubes and graphene have pollutant adsorption properties, which can improve retention efficiency.

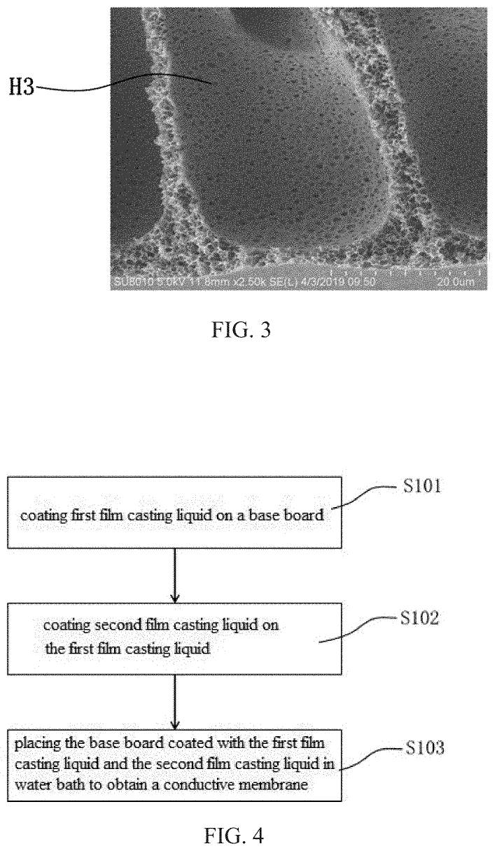

Furthermore, referring to FIG. 3 in combination with FIG. 2, FIG. 3 is another schematic view of an embodiment of a conductive membrane of the present application in a scanning electron microscope, which is a further enlarged photo of the base layer film L1. As shown in FIG. 3, the base layer film L1 includes the finger-shaped holes H1; besides the finger-shaped holes H1, the base layer film L1 is further provided therein with a plurality of pore structures H3. The conductive membrane 10 of the present application includes the aforesaid hole structures, such that after sewage passing through the conductive layer film L3 and the intermediate layer film L2 enters the base layer film L1, the finger-shaped holes H1 and the smaller internal pore structures H3 can filter sewage again, thereby realizing better retention effect.

Further, in this embodiment, a thickness of the conductive layer film L3 is less than a thickness of the base layer film L1. Among them, a thickness of the base layer film L1 is 100-250 micrometers, a thickness of the conductive layer film L3 is less than or equal to 100 micrometers. The pure conductive layer film L3 is very fragile, the configuration that the thickness of the base layer film L1 is greater than that of the conductive layer film L3 can ensure mechanical performance of the conductive membrane.

Referring to FIG. 4, FIG. 4 is a schematic flow chart of an embodiment of a method for preparing a conductive membrane of the present application, which includes the follows.

S101, first film casting liquid is coated on a base board.

Specifically, before the aforesaid operation S101, the preparation method provided by the present application further includes: mixing first polymer membrane material, porogen, and first solvent to form first film casting liquid, wherein the first polymer membrane material includes at least one of polyethersulfone (PES), polyacrylonitrile (PAN), polyvinylidene fluoride (PVDF), polysulfone (PSF), and cellulose acetate (CA); and/or, the porogen includes at least one of polyethylene glycol (PEG) and polyvinylpyrrolidone (PVP), and has a molecular weight of 2000 g/mol-20000 g/mol (for example, 2000 g/mol, 8000 g/mol, 15000 g/mol, or 20000 g/mol); and/or, the first solvent comprises at least one of dimethylformamide (DMF), methylpyrrolidone (NMP), and dimethylacetamide (DMAc); a mass ratio of the first polymer membrane material, the porogen, and the first solvent is (15-22):1:(77-84); then performing static defoaming treatment for the first film casting liquid for 10-15 hours (for example, 10 hours, 12 hours, or 15 hours), when its viscosity is 200 cp-1500 cp (for example, 200 cp, 700 cp, 1000 cp, or 1500 cp), pouring out an appropriate amount of the first film casting liquid onto a base board of a film scraping machine, adjusting a thickness of a doctor blade, and scraping until a membrane is formed.

S102: second film casting liquid is coated on the first film casting liquid.

Specifically, before the aforesaid operation S101 or S102, the preparation method provided by the present application further includes: mixing second polymer membrane material, conductive modified material, and second solvent to form second film casting liquid, wherein the second polymer membrane material includes at least one of polyethersulfone (PES), polyacrylonitrile (PAN), polyvinylidene fluoride (PVDF), polysulfone (PSF), and cellulose acetate (CA); and/or the conductive modified materials includes graphene and carboxylated multi-walled carbon nanotubes; and/or the second solvent comprises at least one of dimethylformamide (DMF), methylpyrrolidone (NMP), and dimethylacetamide (DMAc); preferably, the second solvent is the same as the first solvent, and a mass ratio of the conductive modified material, the second polymer membrane material, and the second solvent is 1:(1-3):(12-17), wherein, in the conductive modified material, a mass ratio of graphene and carboxylated multi-walled carbon nanotubes is 1:(5-15); then performing static defoaming treatment for the second film casting liquid for 10-15 hours (for example, 10 hours, 12 hours, or 15 hours), when its viscosity is 200 cp-1500 cp (for example, 200 cp, 700 cp, 1000 cp, or 1500 cp), pouring out an appropriate amount of the second film casting liquid onto the substrate coated with the first film casting liquid, adjusting the thickness of the doctor blade and scraping until a membrane is formed. In addition, the second film casting liquid is coated on a surface of the first film casting liquid within first preset time after having coated the first film casting liquid, wherein the first preset time is less than or equal to 10 seconds, such as 3 seconds, 8 seconds, or 10 seconds.

S103: the base board coated with the first film casting liquid and the second film casting liquid is placed in a water bath to obtain a conductive membrane; wherein, during a water bath process, a part of the first film casting liquid abutting the base board generates phase transformation and solidifies to be a base layer film of the conductive membrane, a part of the second film casting liquid distancing from the base board generates phase transformation and solidifies to be a conductive layer film of the conductive membrane, and other second film casting liquid and other first film casting liquid merge with each other, generate phase transformation, and solidify into an intermediate layer film of the conductive membrane.

Specifically, the base board coated with the first film casting liquid and the second film casting liquid is placed in a water bath within second preset time after having coated the second film casting liquid to obtain a conductive membrane, wherein the second preset time is less than or equal to 10 seconds, such as 3 seconds, 5 seconds, or 10 seconds. In addition, the base board coated with the first film casting liquid and the second film casting liquid is sequentially subjected to two water bath processes to obtain a conductive membrane, wherein the temperature of the first water bath process is 15° C.-30° C. (for example, 15° C., 20° C., or 30° C.), and the time thereof is 20-40 minutes (such as 20 minutes, 30 minutes, or 40 minutes); the temperature of the second water bath process is 15° C.-30° C. (for example, 15° C., 20° C., or 30° C.), and the time thereof is 10-15 hours (for example, 10 hours, 12 hours, or 15 hours). During the water bath process, the first solvent and the porogen diffuse through an interface between the first film casting liquid and the water phase, and the second solvent diffuses through an interface between the second film casting liquid and the water phase. When the diffusion reaches a certain extent, the first film casting liquid and the second film casting liquid become a thermodynamically unstable system, resulting in their phase separation; then the diffusion further proceeds, coagulation of membrane pores, interphase flow, and rich phase solidification of the first polymer and the second polymer occur to form a membrane. After the water bath process ends, the conductive membrane is automatically separated from the base board, and a membrane cross section of the conductive membrane shows a three-layer film structure of a base layer film, an intermediate layer film, and a conductive layer film.

Differing from the prior art, the membrane formed by scraping the first film casting liquid and the second film casting liquid on the base board in this embodiment is subjected to both phase transformation and solidification processes in the water bath process. During this process, mutual merging will occur at an interface between the first film casting liquid and the second film casting liquid, and finally a conductive membrane including a three-layer film structure is formed: a part of the first film casting liquid abutting the base board generates phase transformation and solidifies to be a base layer film of the conductive membrane, a part of the second film casting liquid distancing from the base board generates phase transformation and solidifies to be a conductive layer film of the conductive membrane, and other second film casting liquid and other first film casting liquid merge with each other, generate phase transformation, and solidify into an intermediate layer film of the conductive membrane. Moreover, the first film casting liquid and the second film casting liquid in this embodiment have different phase transformation characteristics due to different constituent substances. The part of the first film casting liquid abutting the base board is mainly affected by the porogen, and thus forms finger-shaped hole structures during phase transformation; the part of the second film casting liquid distancing from the base board is affected by the carboxylated multi-walled carbon nanotubes as conductive modified material and graphene, and thus forms spongy hole structures during phase transformation; the remaining second film casting liquid and the remaining first film casting liquid merge with each other, and are affected by both the porogen and the conductive modified material, thus the hole structures formed during phase transformation include both finger-shaped and spongy hole structures.

A conductive membrane and a preparation method thereof of the present application are described below in accompany with specific embodiments.

Raw materials used in a method for preparing a conductive membrane of the present application are all obtained by directly purchasing on the market, wherein graphene slurry contains nano-graphene in a mass ratio of 5%, and a solvent is N-methylpyrrolidone (NMP).

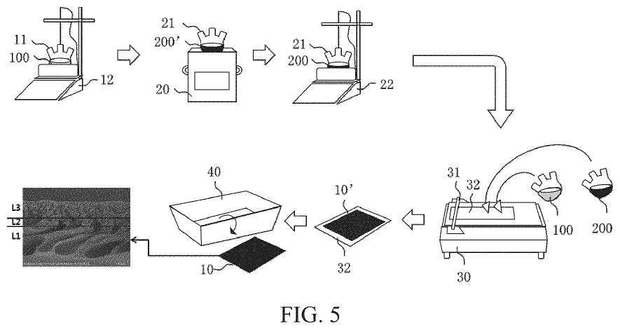

Referring to FIG. 5, FIG. 5 is a schematic flow chart of a specific implementation example of a method for preparing a conductive membrane of the present application. As shown in FIG. 5, a specific preparation method includes the follows.

80 g first solvent dimethylformamide (DMF) is weighed and placed in a three-necked flask 11, the thee-necked flask 11 is placed on a water bath and stirring device 12, and 550 rpm stirring in a 60° C. water bath environment is performed; 1 g polyethylene glycol (PEG) as porogen with a molecular weight of 10000 g/mol and 19 g polyethersulfone (PES) powder as first polymer membrane material are added successively and slowly into the thee-necked flask 11, and stirring is continued for 5.5 hours. Viscosity of the mixed liquid is in the range of 200 cp-1500 cp, and then it is standing for defoaming for 12 hours to obtain first film casting liquid 100.

85 g second solvent dimethylformamide (DMF) is weighed and placed in another three-necked flask 21, then 5 g carboxylated multi-walled carbon nanotubes and 10 g graphene slurry are added to obtain mixed liquid 200′; the three-necked flask 21 is sealed and put into an ultrasonic vibration apparatus 20, and a ultrasonic wave process at 60° C. and 40 kHz for 120 min is performed; then the three-necked flask 21 is transferred to another water bath and the stirring device 22, and stirring at 550 rpm in a 60° C. water bath environment is performed, thus 10 g polyethersulfone (PES) as second polymer membrane material is added, and stirring is continued for 7.5 hours. Viscosity of the mixture is in the range of 200 cp-1500 cp, and then it is standing for defoaming in a dark place for 12 hours to obtain second film casting liquid 200.

An appropriate amount of the first film casting liquid 100 is poured out onto a glass base board 32 of a film scraping machine 30, a thickness of a film scraper 31 is adjusted to 150 microns and scraping is performed until a film is formed.

An appropriate amount of the second film casting liquid 200 is poured out onto the glass base board 32 coated with the first film casting liquid 100, the thickness of the film scraper 31 is adjusted to 250 microns and scraping is performed until a film is formed.

The glass base board 32 carrying an unsolidified film 10′ formed by the first film casting liquid 100 and the second film casting liquid 200 is placed in a water bath device 40 to obtain a conductive membrane 10, wherein the water bath process is divided into two times, the first time of water bath process has a temperature of 25° C. and time of 30 minutes; and the second time of water bath process has a temperature of 25° C. and time of 12 hours.

Among them, during the water bath process, a part of the first film casting liquid 100 abutting the base board generates phase transformation and solidifies to be a base layer film L1 of the conductive membrane, a part of the second film casting liquid 100 distancing from the base board generates phase transformation and solidifies to be a conductive layer film L3 of the conductive membrane, and other second film casting liquid 100 and other first film casting liquid 100 merge with each other, generate phase transformation, and solidify into an intermediate layer film L2 of the conductive membrane. After the water bath process ends, the conductive membrane 10 is automatically separated from the glass base board 32, and a membrane cross section of the conductive membrane 10 obtained after separation shows a three-layer film structure of the base layer film L1, the intermediate layer film L2, and the conductive layer film L3.

The method for preparing the conductive membrane in this embodiment can solve shortcomings of weak film structures, insignificant increase in conductivity, and so on caused by the overall conductive modification (direct blending method), as well as shortcomings of conductive layers being likely to fall off, complicated modification, and so on caused by surface conductive modification (coating method, dipping method, vapor deposition method, interface polymerization method, suction filtration method, grafting method, etc.).

From the perspective of sizes of diameters of holes, the conductive membrane 10 of this embodiment is an ultrafiltration membrane or even a microfiltration membrane, but can achieve filtration effect comparable to that of nanofiltration membranes under an external electric field; moreover, an operation pressure of driving by external pressure is small, and anti-pollution performance is better. The conductive membrane 10 of this embodiment is used for testing, and a base layer film L1′ with the same thickness including only one layer of film structure is further prepared for comparison, thus test results as shown in Table 1 are obtained: in addition, the conductive membrane 10 of this embodiment is used for testing and compared with nanofiltration membranes in the prior art, thus the test results as shown in Table 2 are obtained.

Referring to Table 1, which shows comparison between retention efficiencies and between membrane flux attenuations of the conductive membrane 10 of this embodiment and of the base film L1′ under driving of an external electric field of 75V/cm. It can be seen that retention efficiency of the conductive membrane 10 to Congo red, methylene blue, Ni²⁺ and Cu²⁺ is much higher than that of the base layer film L1′; after 5 weeks of operation, membrane flux attenuation of the conductive membrane 10 to bovine serum albumin (BSA), humic acid (HA) and sodium alginate (SA) is significantly lower than that of the base layer film L1′, the lower the membrane flux attenuation is, the better the anti-fouling performance is. Moreover, an operation pressure of the conductive membrane 10 is 0.1 MPa, while an operation pressure of the base film layer L1′ is 0.5 MPa, that is, the conductive membrane 10 of this embodiment can achieve better retention efficiency and anti-fouling performance than the base film layer L1′ under a lower operation pressure.

TABLE 1
Comparison between retention efficiencies and between membrane flux attenuations
of the conductive membrane 10 and the base layer film L1′

| | Operation | Unit pressure | | |
|---|---|---|---|---|
| Parameter | pressure/MPa | penetration/LMH/Bar | Retention efficiency | Membrane flux attenuation |
| Conductive | 0.1 | 116.2 | Congo red (99.7%) | Bovine serum albumin |
| membrane 10 | | | Methylene blue (93.1%) | (BSA) (24.1%) |
| | | | Ni²⁺ (>95%) | Humic acid (HA) (2.4%) |
| | | | Cu²⁺ (>98%) | Sodium alginate (SA) |
| | | | | (2.6%) |
| Based layer | 0.5 | 12.3 | Congo red (88.7%) | Bovine serum albumin |
| film L1′ | | | Methylene blue (86.7%) | (BSA) (53.2%) |
| | | | Cu²⁺ (28.3%) | Humic acid (HA) (21.3%) |
| | | | Ni²⁺ (26.8%) | Sodium alginate (SA) |
| | | | | (26.4%) |

Referring to Table 2, which shows comparison among retention efficiencies of the conductive membrane 10 of this embodiment and of two kinds of nanofiltration membranes in the prior art under driving of an external electric field of 75V/cm. It can be seen that each of retention efficiencies of the conductive membrane 10 of this embodiment, of the prior art 1, and the prior art 2 to Various dyes (Congo red, methylene blue, methyl blue, methyl orange) achieve about 95%, but an operation pressure of the conductive membrane 10 is 0.1 MPa, while that of each of the prior art 1 and the prior art 2 is 0.5 MPa, that is, the conductive membrane 10 of this embodiment can obtain a retention efficiency comparable to that of nanofiltration membranes under a lower operation pressure.

TABLE 2
Comparison between retention efficiencies of the conductive membrane 10 and the prior art

| | Operation | Unit pressure | Retention | |
|---|---|---|---|---|
| Parameter | pressure/MPa | penetration/LMH/Bar | efficiency | Reference |
| Conductive | 0.1 | 116.2 | Congo red (99.7%) | / |
| membrane 10 | | | Methylene blue (93.1%) | |
| Prior art 1 | 0.5 | 17 | Methyl blue (99.7%) | Liu et. al, Separation and |
| | | | Congo red (99.7%) | Purification Technology, 173 |
| | | | | (2017) 135-143 |
| Prior art 2 | 0.5 | 26 | Methylene blue (98.5%) | Wang Xiaojuan, Water |
| | | | Methyl orange (97.9%) | Treatment Technology, |
| | | | | 2017.01, Volume 43, Issue 1 |

The above descriptions are only embodiments of the present application, but are not intended to limit the patent scope of the present application. Any equivalent structure or equivalent process transformation made using content of the specification and drawings of the present application, or direct or indirect application in other related technical fields, is equally included in the patent protection scope of the present application.

What is claimed is:

1. A conductive membrane, wherein
the conductive membrane comprises a porous base layer film, a porous intermediate layer film, and a porous conductive layer film which are disposed layer by layer in sequence;
wherein at least some holes of the base layer film are communicated with holes of the conductive layer film through holes of the intermediate layer film, and material of the intermediate layer film comprises material of the base layer film and of the conductive layer film.

2. The conductive membrane according to claim 1, wherein
the base layer film comprises first polymer film material, the conductive layer film comprises second polymer film material and conductive modified material, and the intermediate layer film comprises the first polymer film material, the conductive modified material, and the second polymer film material.

3. The conductive membrane according to claim 2, wherein
the conductive modified material comprises graphene and carboxylated multi-wall carbon nanotubes; and/or
the first polymer film material and the second polymer film material comprise at least one of polyethersulfone (PES), polyacrylonitrile (PAN), polyvinylidene fluoride (PVDF), polysulfone (PSF), and cellulose acetate (CA).

4. The conductive membrane according to claim 2, wherein the first polymer film material is the same as the second polymer film material.

5. The conductive membrane according to claim 1, wherein
the holes of the base layer film comprise finger-shaped holes, the holes of the conductive layer film comprise spongy holes and columnar holes, and the holes of the intermediate layer film comprise the spongy holes and the finger-shaped holes.

6. The conductive membrane according to claim 5, wherein
sizes of the holes of the base layer film, of the intermediate layer film, and of the conductive layer film gradually reduce.

7. The conductive membrane according to claim 6, wherein
in a direction from the base layer film to the conductive layer file, the finger-shaped holes of the base layer film have diameters of 15-50 micrometers and lengths of 30-200 micrometers; and/or
in the direction from the base layer film to the conductive layer file, diameters of the spongy holes of the conductive layer film are less than or equal to 10 micrometers, and the columnar holes have diameters of 100 nanometers to 1 micrometer and lengths being less than or equal to 10 micrometers.

8. The conductive membrane according to claim 5, wherein the base layer film is further provided therein with a plurality of pore structures being less than the finger-shaped holes.

9. The conductive membrane according to claim 1, wherein
a thickness of the conductive layer film is less than a thickness of the base layer film.

10. The conductive membrane according to claim 8, wherein
the thickness of the conductive layer film is less than or equal to 100 micrometers; and the thickness of the base layer film ranges from 100 micrometers to 250 micrometers.

11. A method for preparing a conductive membrane, wherein the method comprises:
coating first film casting liquid on a base board;
coating second film casting liquid on the first film casting liquid; and
placing the base board coated with the first film casting liquid and the second film casting liquid in water bath to obtain the conductive membrane; wherein a part of the first film casting liquid abutting the base board generates phase transformation and solidifies to be a base layer film of the conductive membrane, a part of the second film casting liquid distancing from the base board generates phase transformation and solidifies to be a conductive layer film of the conductive membrane, and other second film casting liquid and other first film casting liquid merge with each other, generate phase transformation, and solidify into an intermediate layer film of the conductive membrane.

12. The method according to claim 11, wherein
before the coating first film casting liquid on a base board, the preparation method further comprises:
mixing first polymer membrane material, porogen, and first solvent to form first film casting liquid; and mixing second polymer membrane material, conductive modified material, and second solvent to form second film casting liquid; wherein viscosity of the first film casting liquid and of the second film casting liquid is 200 cp-1500 cp.

13. The method according to claim 12, wherein
the mixing first polymer membrane material, porogen, and first solvent to form first film casting liquid comprises: stirring a mixture of the first polymer membrane material, the porogen, and the first solvent in a water bath environment; and/or
the mixing second polymer membrane material, conductive modified material, and second solvent to form second film casting liquid comprises: performing ultrasonic wave processing for a mixture of the conductive modified material and the second solvent, and stirring a mixture of the second polymer membrane material, the conductive modified material, and the second solvent in a water bath environment.

14. The method according to claim 12, wherein
before the coating first film casting liquid on a base board, the preparation method further comprises:
performing standing defoaming treatment for the first film casting liquid for 10-15 hours; and performing standing defoaming treatment for the second film casting liquid for 10-15 hours.

15. The method according to claim 12, wherein
the conductive modified material comprises graphene and carboxylated multi-wall carbon nanotubes; and/or
the first polymer film material and the second polymer film material comprise at least one of polyethersulfone (PES), polyacrylonitrile (PAN), polyvinylidene fluoride (PVDF), polysulfone (PSF), and cellulose acetate (CA); and/or
the porogen comprises at least one of polyethylene glycol (PEG) and polyvinylpyrrolidone (PVP), and has a molecular weight of 2000 g/mol-20000 g/mol; and/or
the first solvent and the second solvent comprise at least one of dimethylformamide (DMF), methylpyrrolidone (NMP), and dimethylacetamide (DMAc).

16. The method according to claim 15, wherein the second solvent is the same as the first solvent.

17. The method according to claim 12, wherein
in the first film casting liquid, a mass ratio of the first polymer membrane material, the porogen, and the first solvent is (15-22):1:(77-84); and
in the second film casting liquid, a mass ratio of the conductive modified material, the second polymer membrane material, and the second solvent is 1:(1-3):(12-17).

18. The method according to claim 17, wherein
the conductive modified material comprises graphene and carboxylated multi-wall carbon nanotubes, and a mass ratio of graphene and carboxylated multi-walled carbon nanotubes is 1:(5-15).

19. The method according to claim 11, wherein
the coating second film casting liquid on the first film casting liquid comprises: coating the second film casting liquid on a surface of the first film casting liquid within first preset time after having coated the first film casting liquid, wherein the first preset time is less than or equal to 10 seconds; and/or
the placing the base board coated with the first film casting liquid and the second film casting liquid in water bath to obtain the conductive membrane comprises: placing the base board coated with the first film casting liquid and the second film casting liquid in a water bath within second preset time after having coated the second film casting liquid to obtain a conductive membrane, wherein the second preset time is less than or equal to 10 seconds.

20. The method according to claim 11, wherein
the placing the base board coated with the first film casting liquid and the second film casting liquid in water bath to obtain the conductive membrane comprises:
sequentially performing two water bath processes for the base board coated with the first film casting liquid and the second film casting liquid to obtain a conductive membrane, wherein the first water bath process has a temperature of 15° C.-30° C. and time of 20-40 minutes; the second water bath process has a temperature of 15° C.-30° C. and time of 10-15 hours.
